(19) United States
(12) Patent Application Publication
(10) Pub. No.: US 2014/0074604 A1
(43) Pub. Date: Mar. 13, 2014

(54) PREDICTIVE ANALYTICS FOR MOBILE ADVERTISING

(71) Applicant: Voltari Operating Corp., Bellevue, WA (US)

(72) Inventors: David Castillo, Gilbert, AZ (US); Donald Kridel, Kirkwood, MO (US); Aaron Epstein, Alpharetta, GA (US)

(73) Assignee: Voltari Operating Corp., Bellevue, WA (US)

(21) Appl. No.: 14/023,191

(22) Filed: Sep. 10, 2013

Related U.S. Application Data
(60) Provisional application No. 61/699,237, filed on Sep. 10, 2012.

(51) Int. Cl. G06Q 30/02

(52) U.S. Cl. CPC G06Q 30/0267
USPC 705/14.53

(57) ABSTRACT

The present invention provides systems and methods for facilitating the creation and management of marketing campaigns, as well as the delivery of advertisements associated with those campaigns. Some embodiments provide a Mobile Marketing Platform (“MMP”) configured to determine an audience profile based on received marketing campaign information (e.g., delivery time, demographic information, ad copy). The determined audience profile describes a market segment that is expected or predicted to respond positively to the marketing campaign. The MMP then receives an indication that a particular user is accessing a resource (e.g., content item, Web site, mobile application). The MMP then compares the attributes of the user (e.g., demographics, location, device type) with multiple stored audience profiles and select the audience profile that best matches the user and his associated attributes. The MMP then serves an advertisement of the marketing campaign associated with the selected audience profile.

### PRIORITY CLAIM

This application claims the benefit of U.S. Provisional Application Ser. No. 61/699,237 filed Sep. 10, 2012, the contents of which are incorporated herein.

### FIELD OF THE INVENTION

The present disclosure relates to methods and systems for mobile advertising and, more particularly, to methods and systems that apply predictive analytics to determine target audience profiles for advertisement delivery.

### BRIEF DESCRIPTION OF THE DRAWINGS

Preferred and alternative examples of the present invention are described in detail below with reference to the following drawings:

FIG. 1 illustrates an example block diagram of an example embodiment of a mobile marketing platform;

FIGS. 2A-2J depict example user interface screens provided by an example embodiment;

FIGS. 3A-3K illustrate implementation details associated with various embodiments;

FIG. 4 is a flow diagram of an example advertisement provider process according to an example embodiment; and

FIG. 5 is a block diagram of an example computing system for implementing a mobile marketing platform according to an example embodiment.

### DETAILED DESCRIPTION

Embodiments described herein provide enhanced computer- and network-based methods and systems for mobile advertising. Example embodiments provide a mobile marketing platform (“MMP”) configured to facilitate the creation and management of marketing campaigns, as well as the delivery of advertisements associated with those campaigns. Using the MMP, a marketer may provide information about a marketing campaign, an advertisement, and a target audience for the campaign. The information is typically provided in the form of attributes that describe the campaign, preferred delivery times and targets, preferred user attributes, and the like.

The MMP then determines an audience profile (sometimes also called an “audience cube” herein) based on received campaign information together with information about transactions executed by mobile device users. The determined audience profile describes a market segment that is expected or predicted to respond positively (e.g., by engaging with an advertisement, by making a purchase, by providing contact information) to the marketing campaign. Machine learning and prediction techniques may be employed to discover relationships or correlations between various attributes, such as user/customer demographics, time and date, market category, mobile device features, geography, site audiences, and the like. For example, the MMP may determine that customers in a particular geographic region using a particular mobile device type or platform previously responded particularly well to an advertisement for a sports-related item or other offer. The MMP may exploit this understanding of previous transactions and other actions in determining audience profiles that are suitable for given marketing campaigns.

The MMP may also make real-time (or substantially real time) decisions regarding what advertisements to serve based on the determined audience profiles. For example, the MMP may receive an indication that a particular user is accessing a resource (e.g., content item, Web site, mobile application). The MMP may then compare the attributes of the user (e.g., demographics, location, device type) with multiple stored audience profiles and select the audience profile that best matches the user and his associated attributes. The selection technique employs an audience scorecard derived from the predictive models that have been designed to measure correlations in the attributes described above. The MMP may then serve or otherwise provide an advertisement of the marketing campaign associated with the selected audience profile. In addition, the MMP may record the user's response to the served advertisement, and then feed this information back in order to update audience profiles and otherwise improve the predictive power of the MMP with respect to future interactions.

The described techniques provide distinct advantages over existing approaches. In particular, existing approaches do not take the brand, campaign, and creative information into consideration when making an advertisement selection for each publisher advertisement request. In addition, existing approaches do not automate the process of optimizing advertisement selection while campaigns are still in progress. These approaches require the manual addition or removal of publishers (or advertisements) from consideration if an advertisement is not performing well.

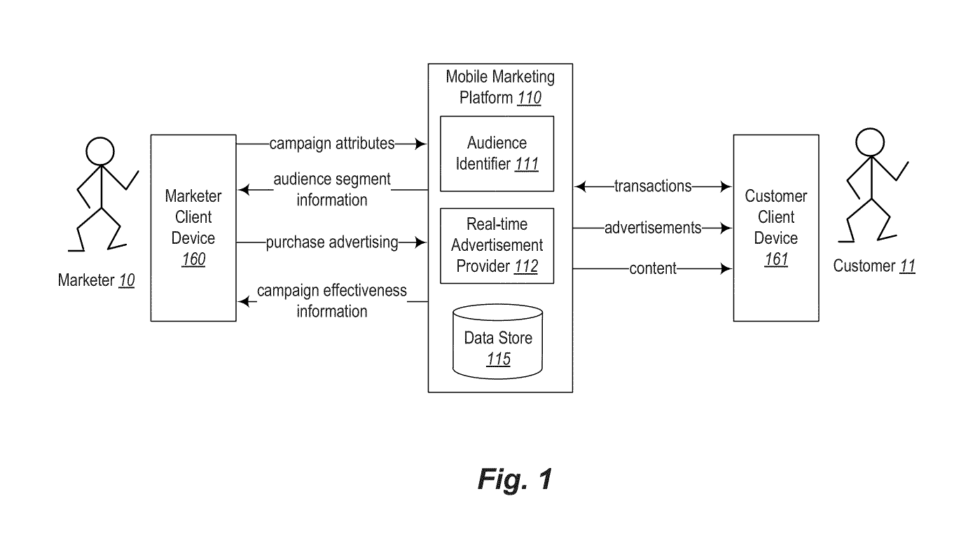

FIG. 1 illustrates an example block diagram of an example embodiment of a mobile marketing platform. In particular, FIG. 1 depicts a mobile marketing platform 110 interacting with a marketer user 10 to determine advertisements to provide to a customer user 11. The MMP 110 includes an audience identifier 111, a real-time advertisement provider 112, and a data store 115 that together implement or otherwise provide at least some of the techniques described herein.

In the illustrated example, the marketer 10 provides indications of campaign attributes to the MMP 110. The campaign attributes may include attributes of a marketing campaign, an associated advertisement, and target audience. Marketing campaign attributes may include a brand name, keywords, campaign objective, a success metric (e.g., click through, purchase), a content channel (e.g., games, sports, music, technology, lifestyle, fashion), or the like. Advertisement attributes may include an advertisement type (e.g., banner ad, popup), an advertisement language (e.g., English, Spanish), an advertisement size (e.g., pixel dimensions) or length (e.g., 10 second video), or the like. Target audience attributes may include demographic information (e.g., age, gender, ethnicity, income), time of day, day of week, device type (e.g., tablet computer, smart phone), device platform (e.g., Android, iOS), or the like.

The audience identifier 111 then determines an audience profile based on the received campaign attributes. The audience identifier 111 may employ machine learning and/or prediction techniques to generate an audience profile representing attributes that are predicted or likely to engage with the marketing campaign. The predictions may be based on previous interactions or transactions executed or initiated by mobile device users/customers. In some embodiments, the MMP 110 is associated with an online marketplace that is configured to provide content, services, and/or applications to mobile device users in exchange for payment. The MMP 110 may track or otherwise receive information about the interactions of the mobile device users with the online marketplace, and use that information to determine audience profiles.

The real-time advertisement provider 112 dynamically determines effective advertisements to provide to the customer 11 based on information about the customer 11 and the determined audience profile. In one embodiment, the advertisement provider 112 receives an indication of an online resource (e.g., provided by a Web site, an online marketplace, or other information/content provider) that is being accessed by the customer 11. In response to this indication, the advertisement provider 112 determines an advertisement that is a match for the customer 11. Determining the advertisement may include determining a confidence score for each of multiple marketing campaigns, the score reflecting the suitability of a particular campaign for the customer 11. The confidence score may be based on a measure of similarity between the customer 11 and an audience profile, such as whether attributes of the customer 11 match attributes of the audience profile.

Once the advertisement is served to the customer 11, the MMP 110 tracks the customer's response to the advertisement. Information about the customer's response is recorded by the MMP 110 in the data store 115 for future use by the audience identifier 111 and/or the real-time advertisement provider 112. Information about the customer's response may include whether or not the customer 11 clicked on the advertisement, whether the customer 11 purchased the good or service advertised, or the like. The data store 115 may record other information, such as marketing campaign information, user accounts, machine learning models, and the like.

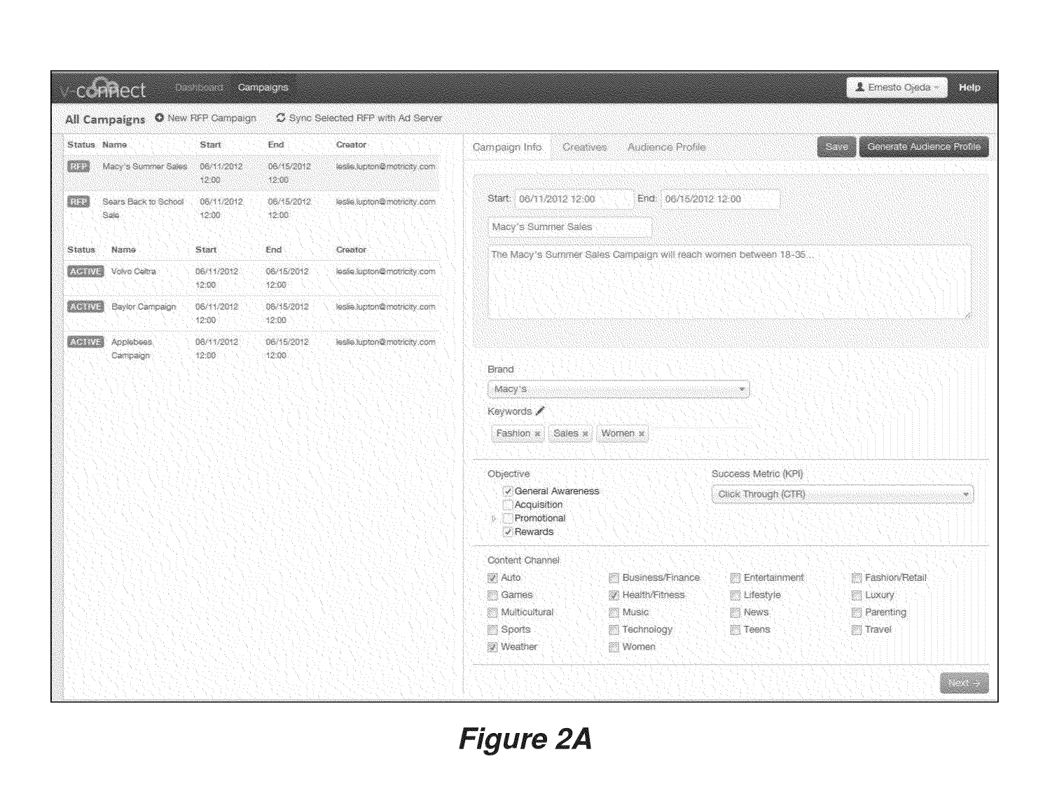

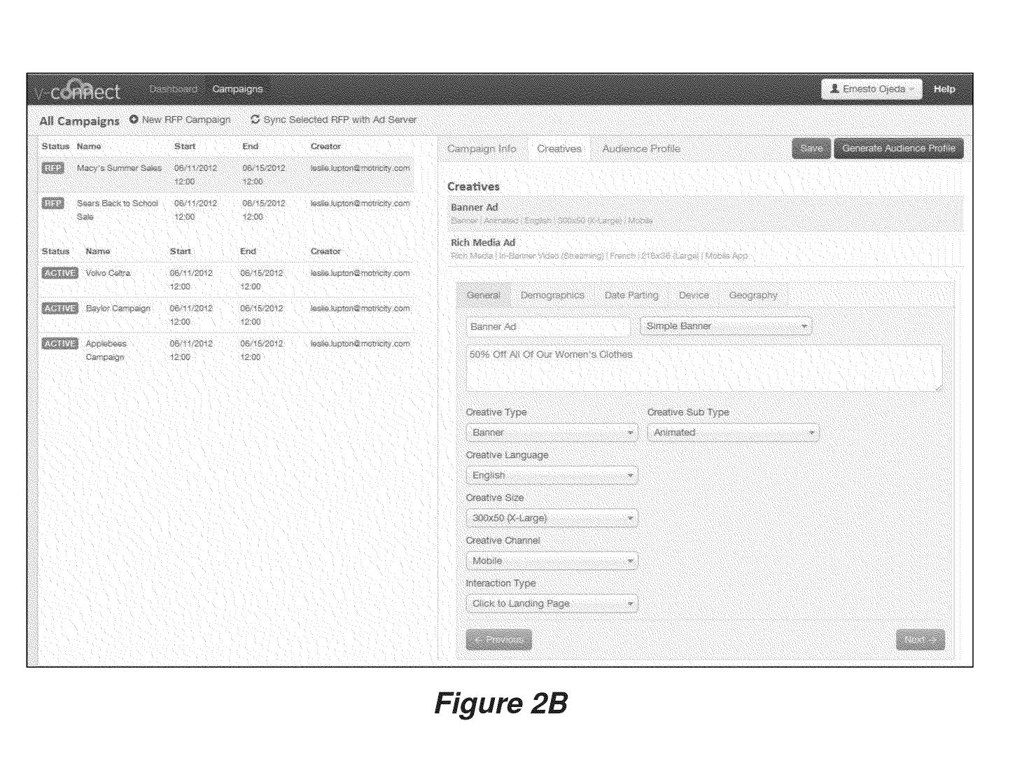

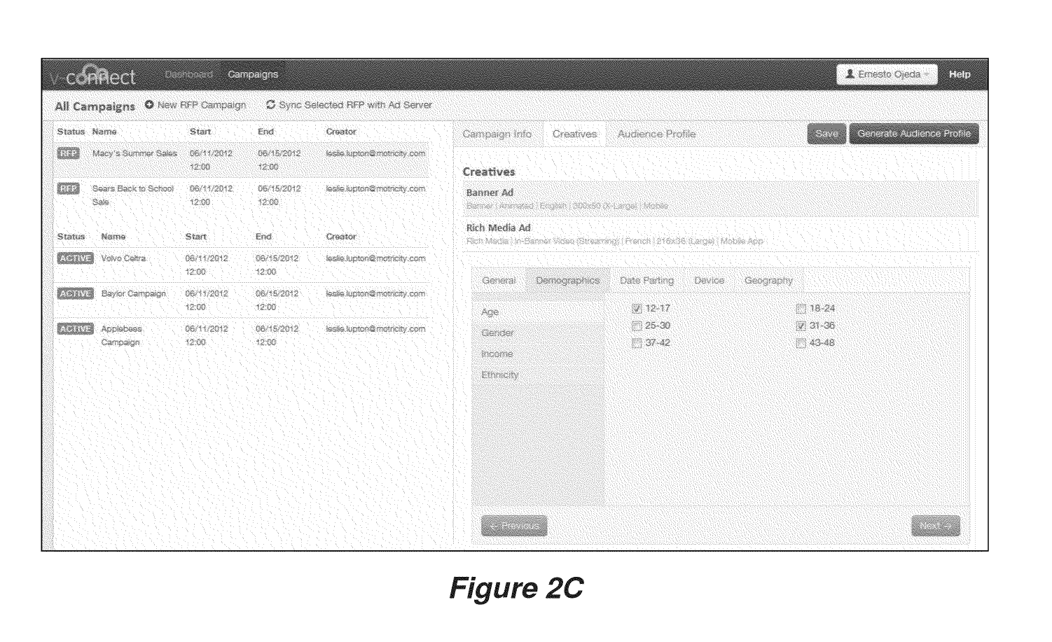

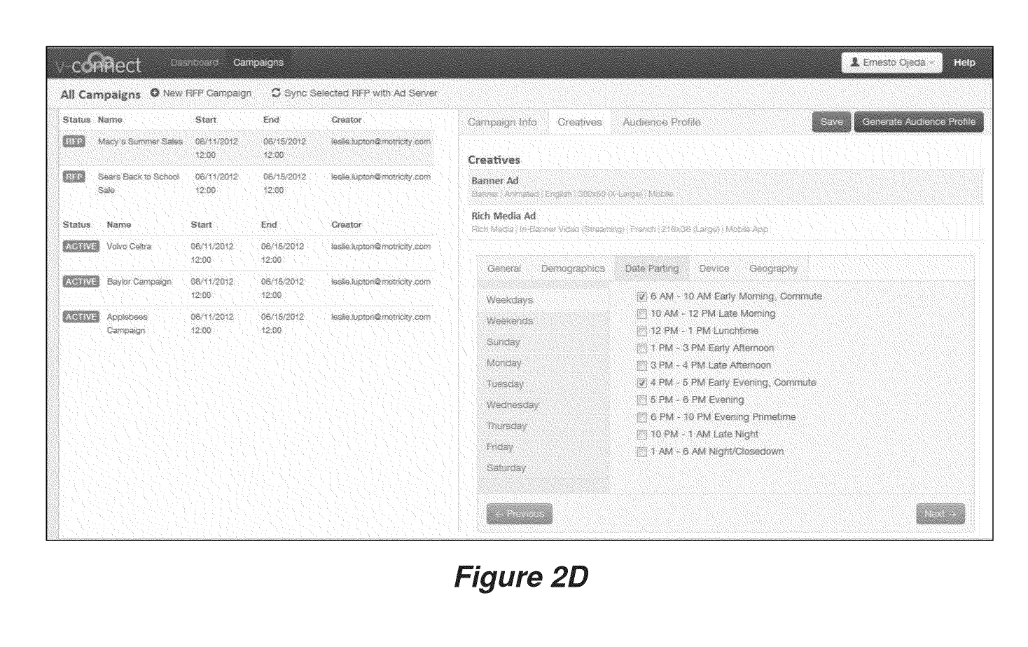

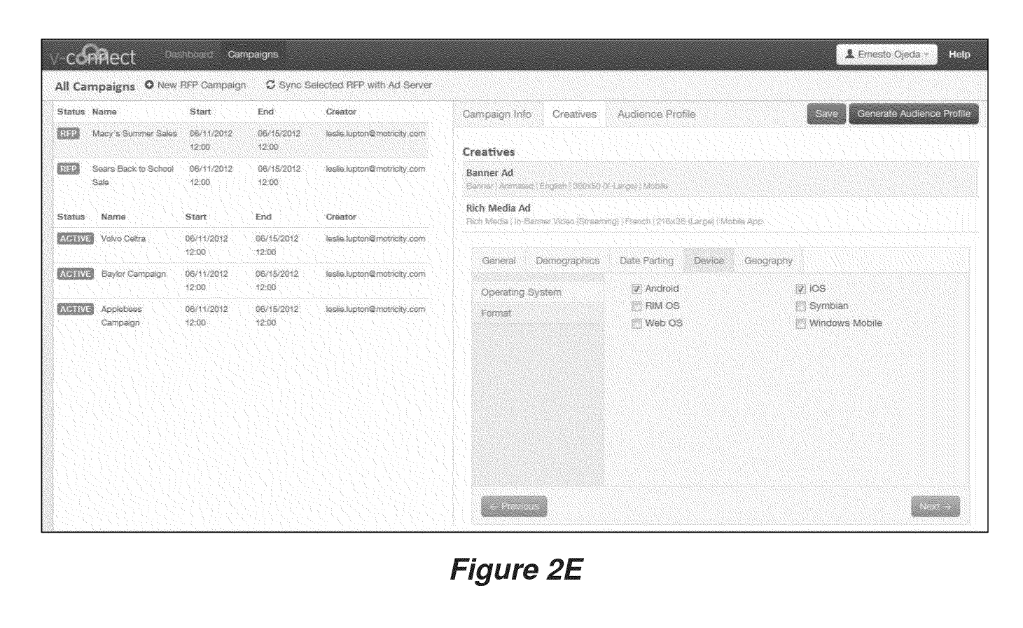

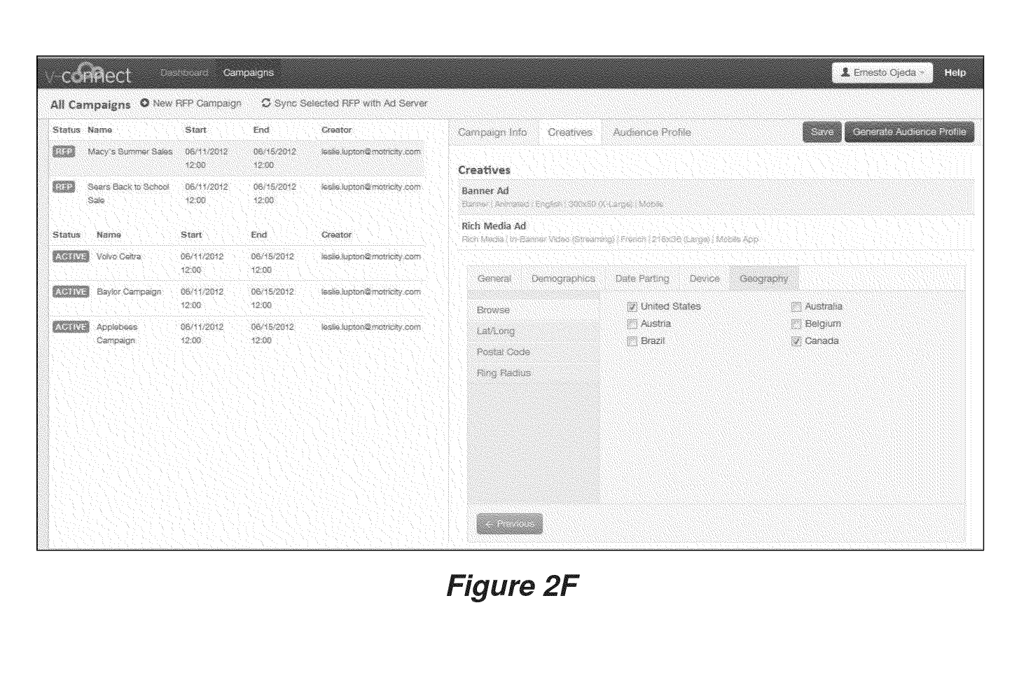

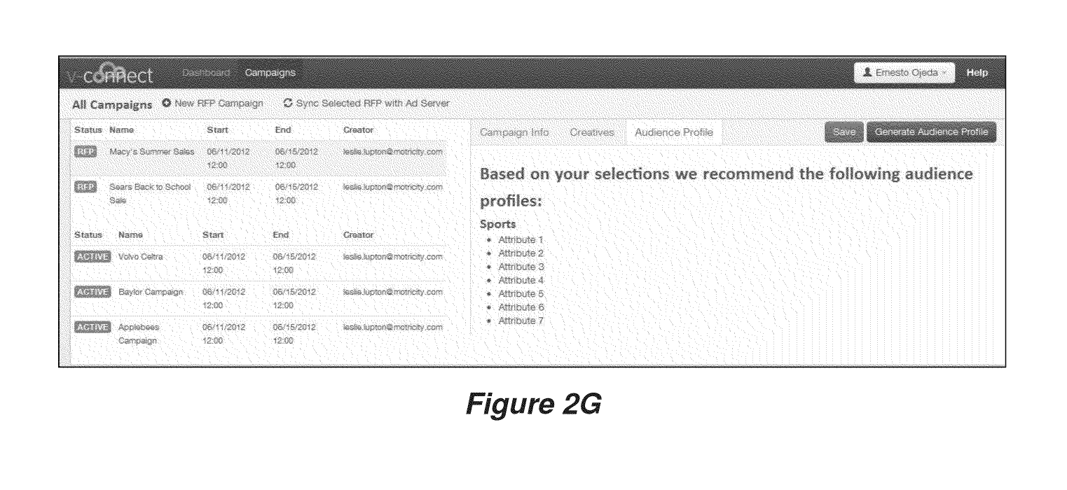

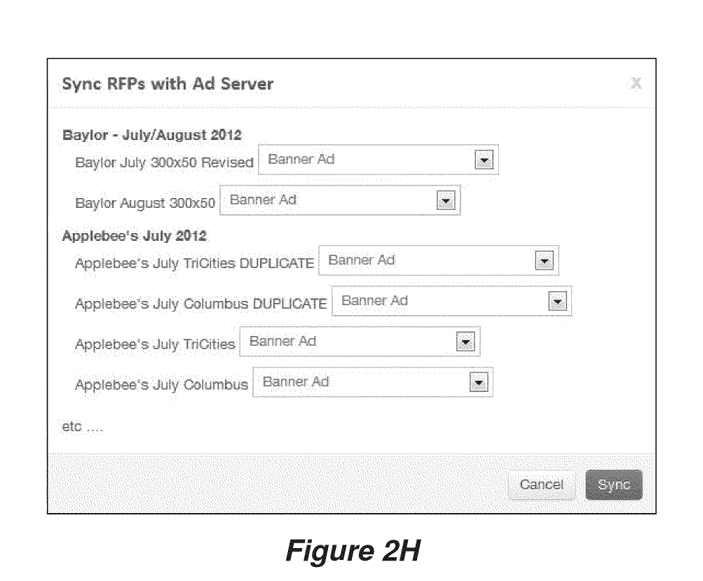

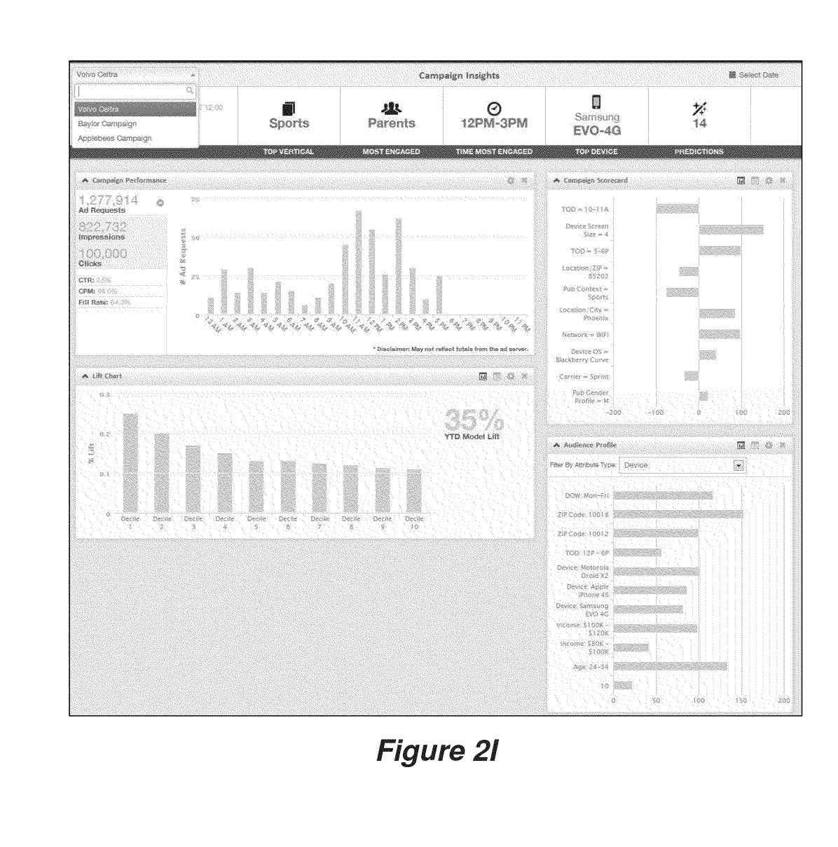

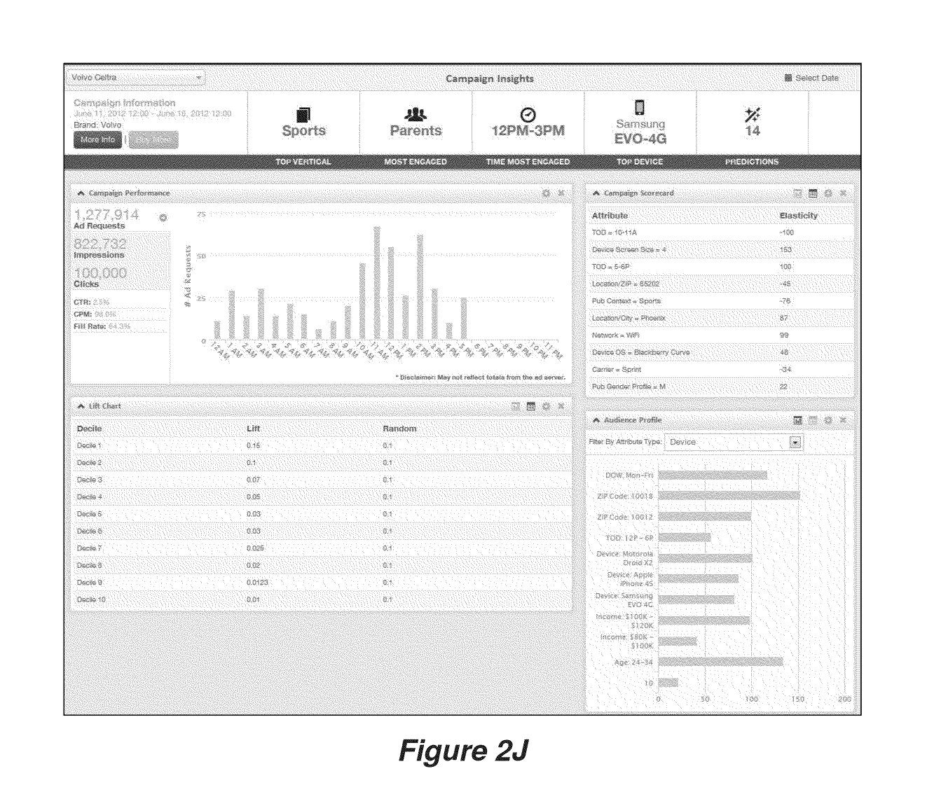

FIGS. 2A-2J depict example user interface screens provided by an example embodiment. The illustrated screens are part of a user interface for a marketing campaign management tool that can be used to interact with or otherwise configure the MMP 110.

More particularly, FIG. 2A illustrates a screen for providing marketing campaign attributes, including brand name, keywords, objective, success metric, and content channel. A user can interact with the illustrated screen to create a new marketing campaign. In the illustrated example, the user is creating a new marketing campaign for the Macy's brand, and has provided or specified corresponding keywords (e.g., “fashion,” “sales,” “women”), a success metric (e.g., click through), and content channels.

FIG. 2B illustrates a screen for providing advertisement attributes, including advertisement type, language, size, channel, interaction type, and the like. In the illustrated example, the user has specified a banner advertisement along with corresponding text (e.g., “50% Off All Of Our Women's Clothes”), language (e.g., English), size, and channel (e.g., Mobile), and interaction type (e.g., click to landing page).

FIG. 2C illustrates a screen for providing target audience demographic attributes. In the illustrated example, the user has specified that the campaign should target users in the age ranges of 12-17 and 31-36 years. Other controls titled Gender, Income, and Ethnicity may be used to access sub-screens configured to specify further demographic attributes.

FIG. 2D illustrates a screen for providing target audience time and day attributes. In the illustrated example, the user has specified that the advertisement should run on weekends between 1-3 PM, 3-4 PM, 5-6 PM, and 6-10 PM. Other controls may be used to access sub-screens configured to specify other and/or additional days and/or times during which the advertisement should run.

FIG. 2E illustrates a screen for providing target audience device attributes. In the illustrated example, the user has specified that the campaign should target mobile devices having the Android or iOS operating system. The control titled Format may be used to access a sub-screen configured to specify the device format (e.g., phone, tablet, wearable device).

FIG. 2F illustrates a screen for providing target audience geography/location attributes. In the illustrated example, the user has specified that the campaign should be directed to devices within the United States or Canada. Other controls may be used to access sub-screens configured to specify the geographic reach of the campaign based on other attributes, including latitude and longitude, postal codes, ring radius, or the like.

FIG. 2G illustrates a screen for providing information about a determined audience profile. The illustrated screen is provided in response to the user specifying the attributes of the campaign. The MMS 110 automatically determines, based on the user-specified attributes, one or more audience profiles that match or are otherwise correlated with the specified attributes.

FIG. 2H illustrates a screen for synchronizing campaign information with an advertising server. The illustrated screen is provided in response to user selection of the control entitled “Sync Selected RFP with Ad Server” (visible in FIG. 2G, for example). The illustrated screen allows the user to synchronize marketing campaigns created via the described interface with the MMS 110.

FIGS. 2I and 2J illustrate screens that present information about the effectiveness of marketing campaigns. The illustrated screens are provided after a particular marketing campaign has been in process for some time. The screens provide multiple views and graphical depictions of the effectiveness of a particular campaign, including number of requests, number of impressions, clicks, time of day, location, device type, network type, carrier type, demographic information, and the like.

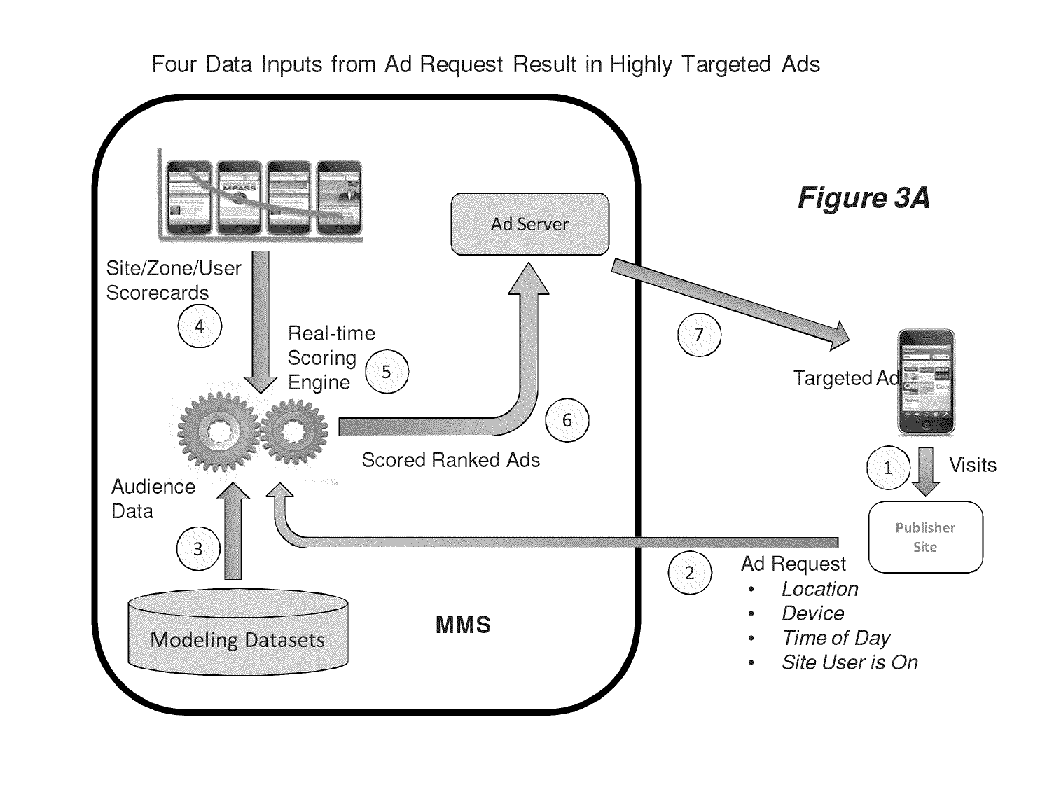

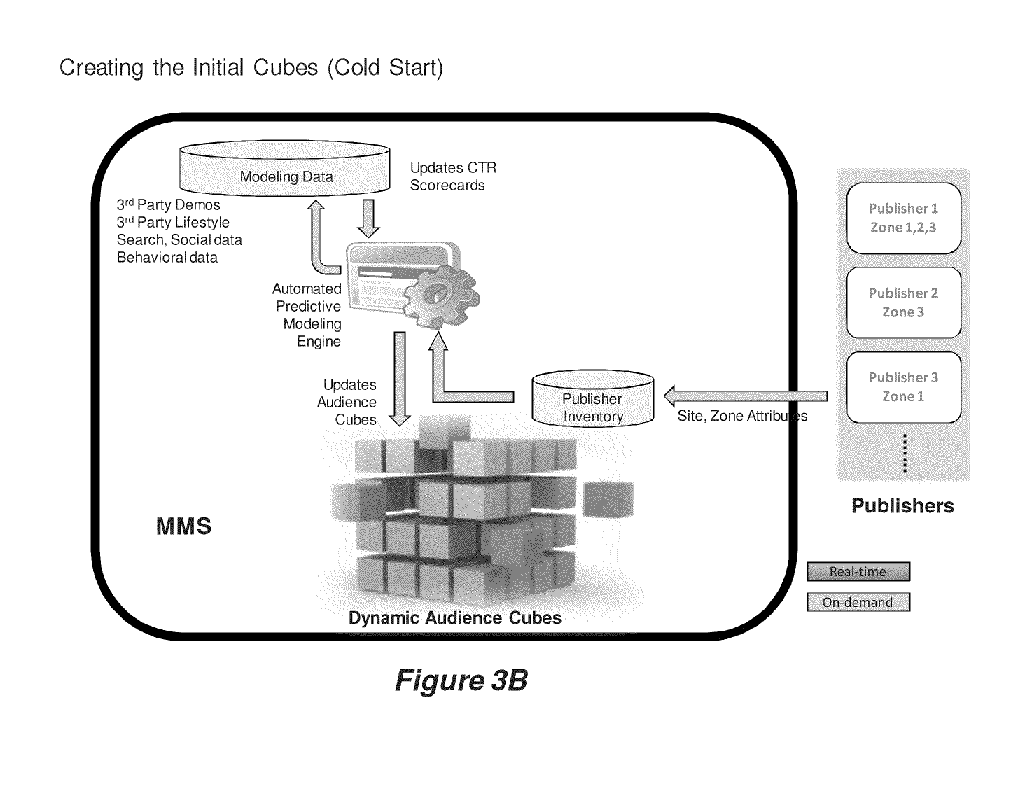

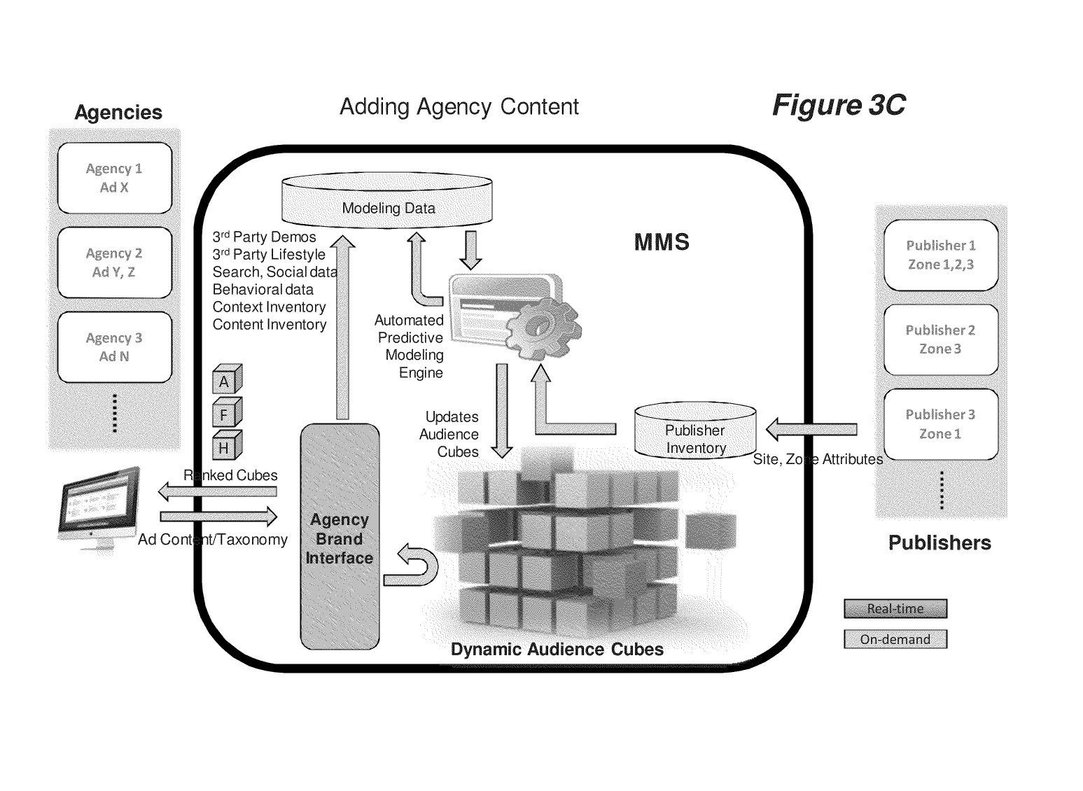

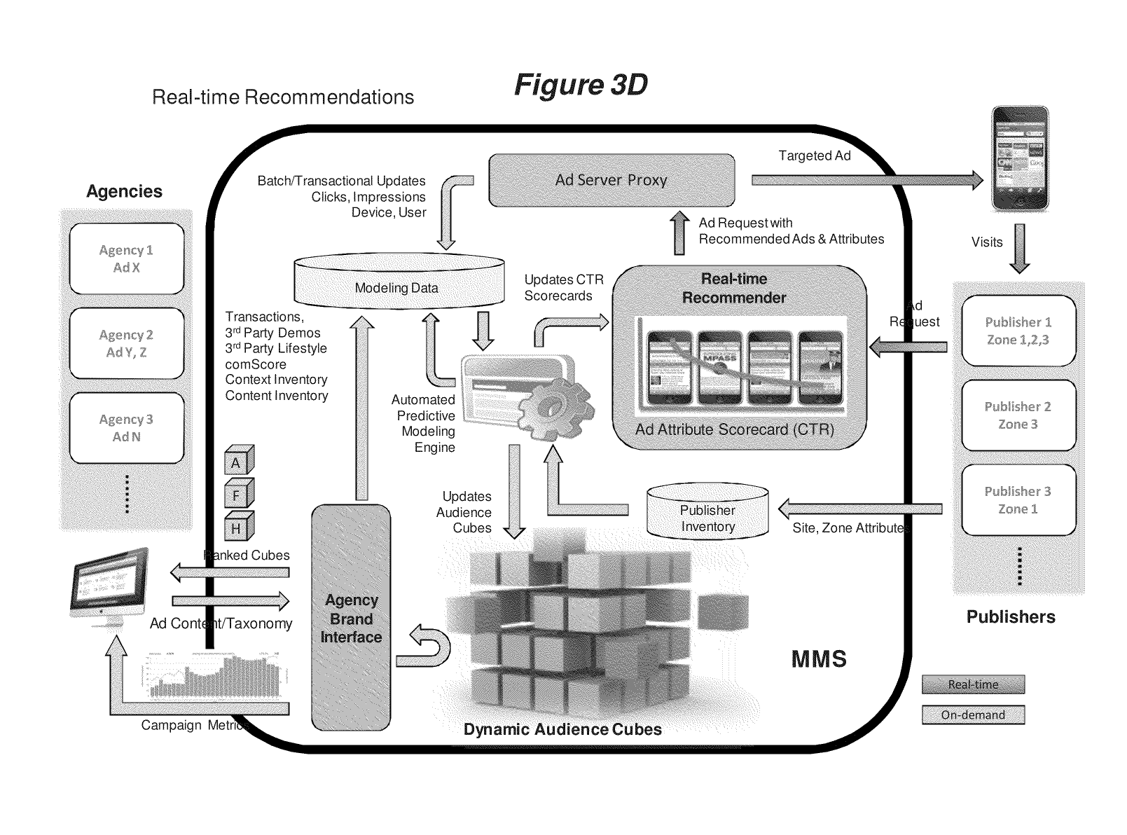

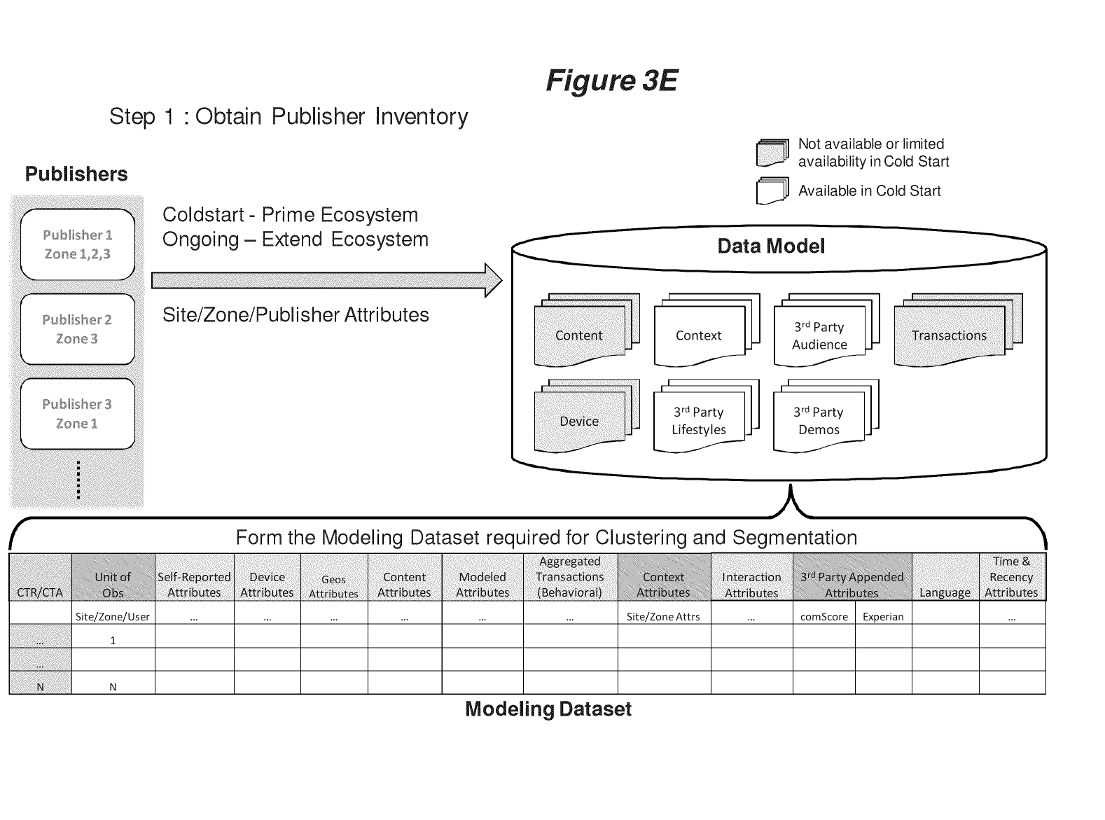

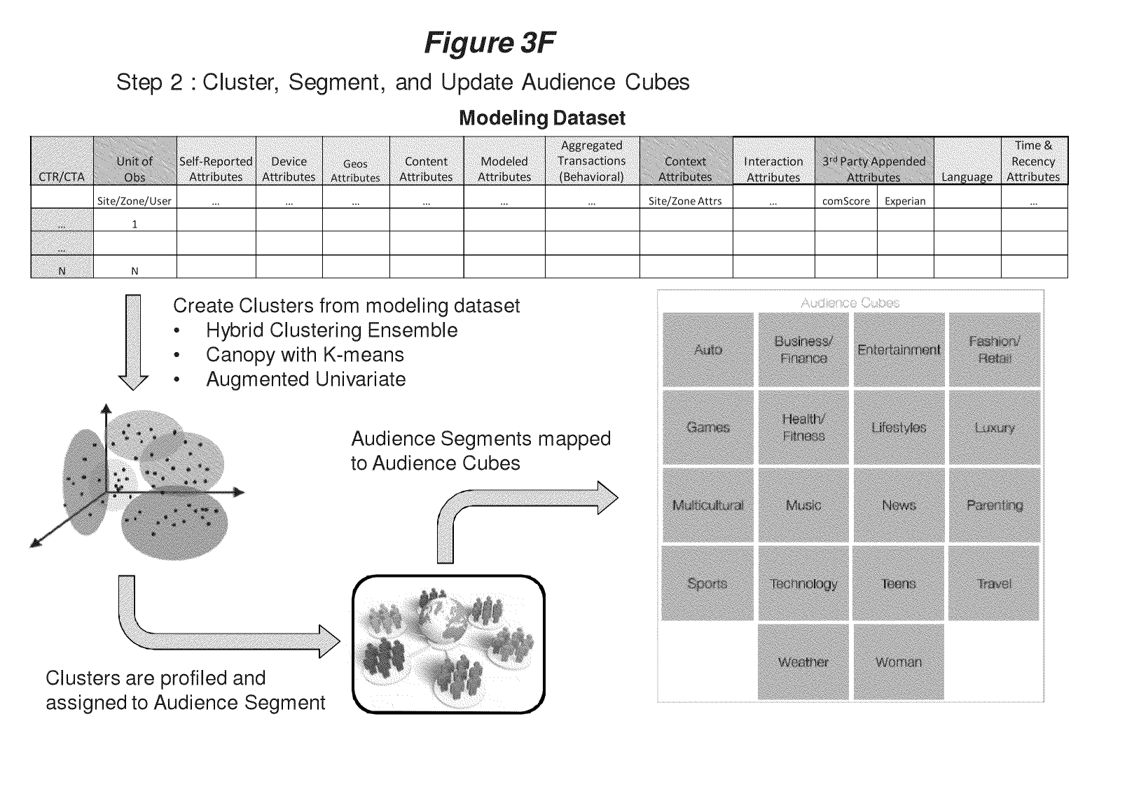

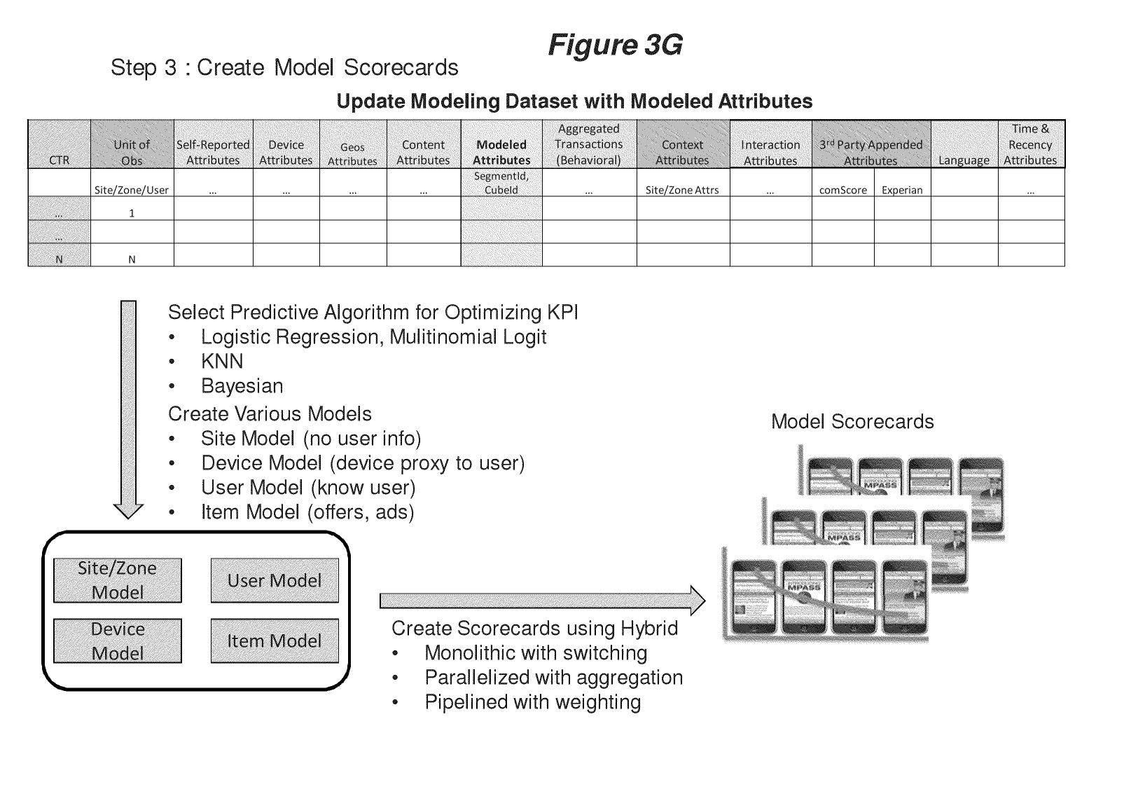

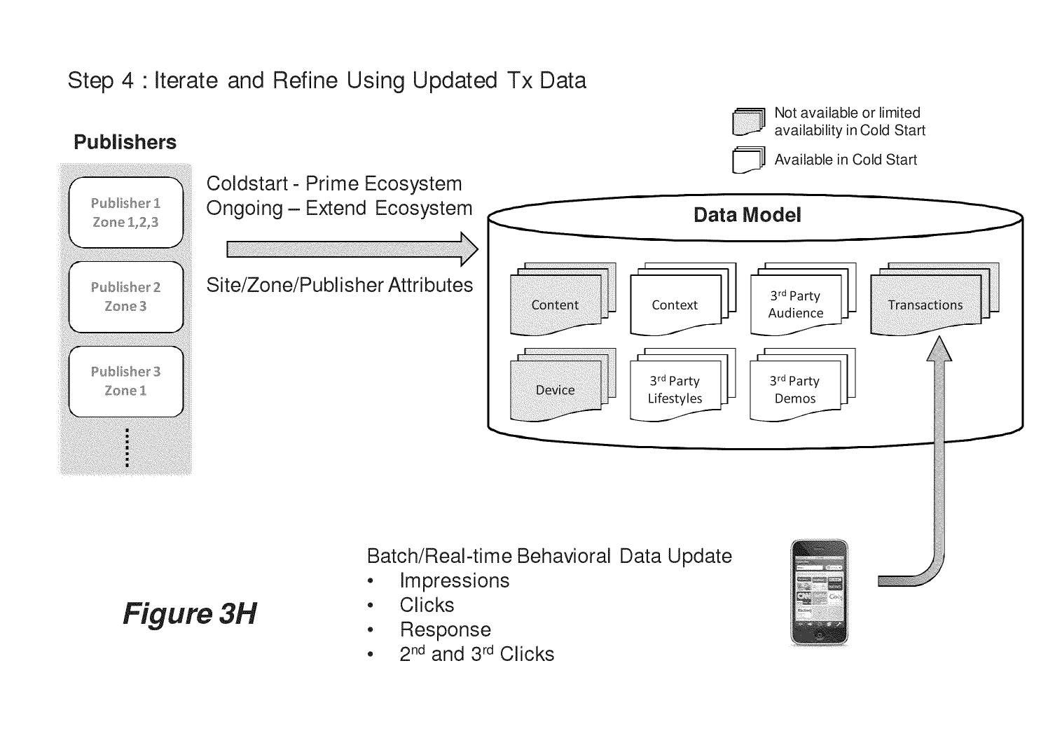

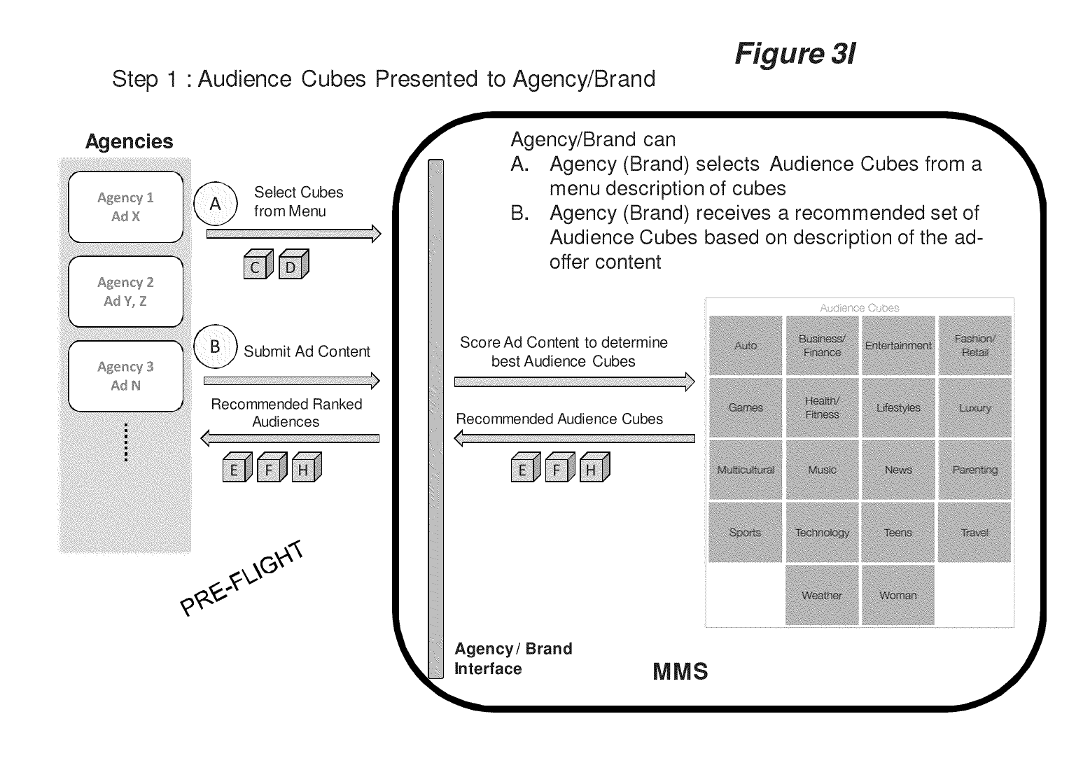

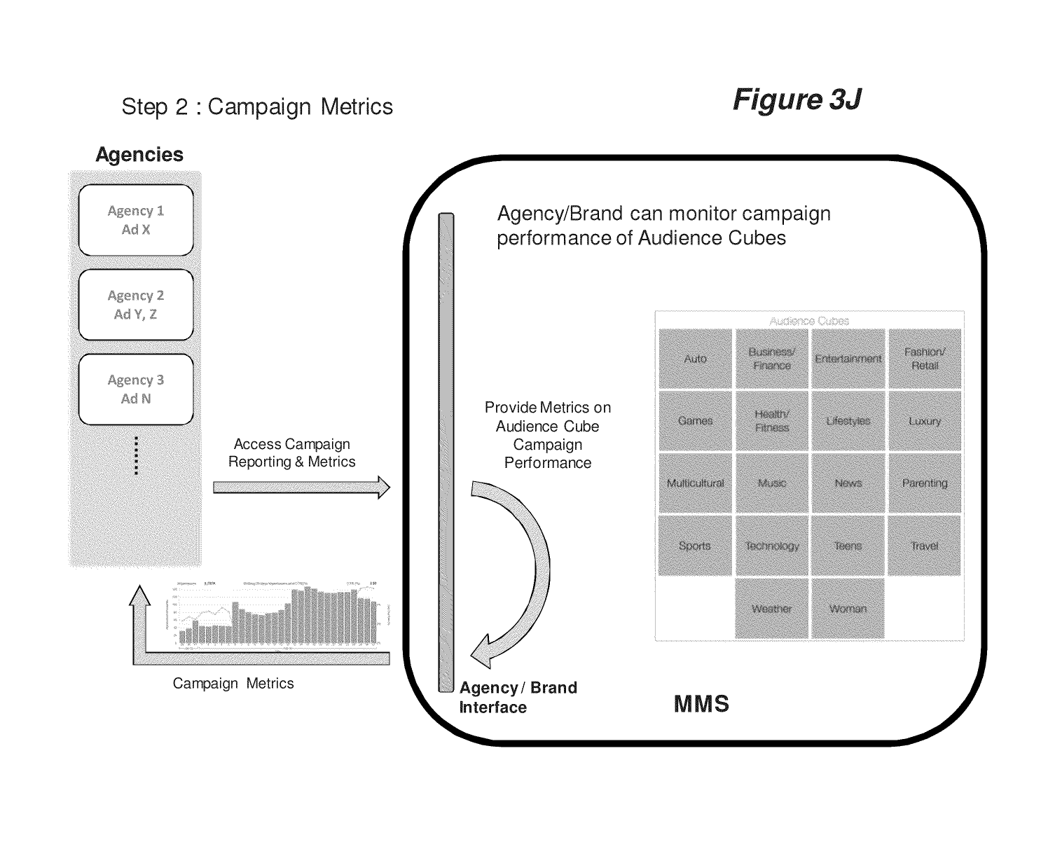

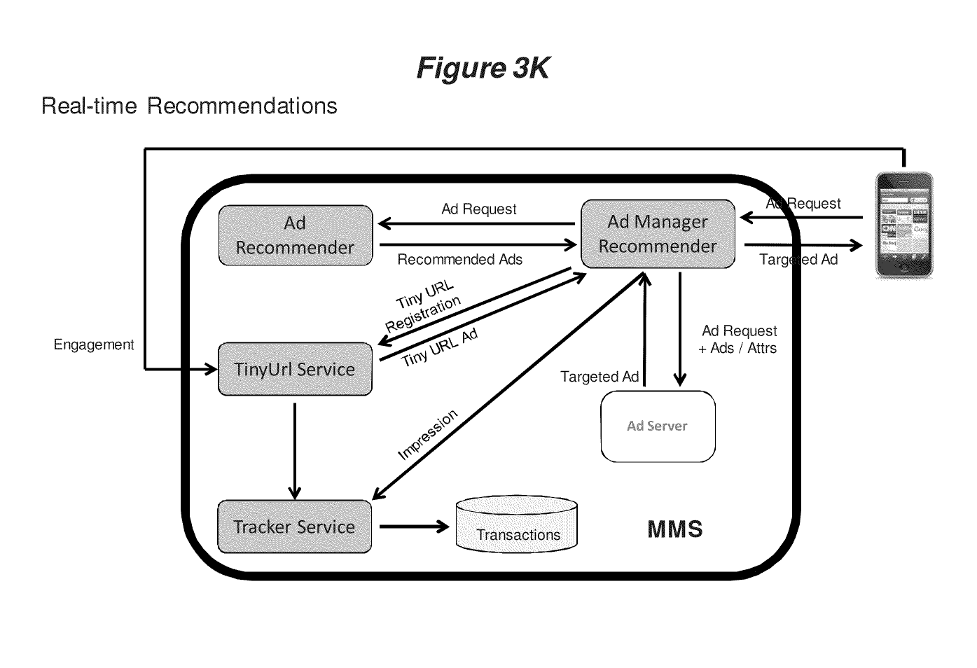

FIGS. 3A-3K illustrate implementation details associated with various embodiments. FIG. 3A depicts data flow in an example embodiment. As shown, a mobile device is used to visit a publisher site (e.g., a web site, an app store). This results in the generation of an advertisement request from the publisher site to the MMS. The advertisement request includes four attributes, device location, device type information (e.g., OS, format, platform, etc.), time of day, and the site being accessed. The MMS then determines and scores advertisements, based on (1) the received attributes, (2) audience data contained in modeling datasets and (3) site/zone/user scorecards. The ranked advertisements are provided to an advertisement server, which in turn transmits one of the advertisements to the mobile device.

FIGS. 3B-3D illustrate an overview of the creation and management of audience cubes (audience profiles) according to example embodiments. FIG. 3B illustrates a “cold start” condition, which is a time prior the provision of any advertisements. Initially, audience cubes are created and/or updated based on (1) attributes and information related to publishers (e.g., Web sites, app stores) and (2) modeling data, including social and behavioral data. In FIG. 3C, marketing (agency) content is incorporated. A marketing user may use an interface such as is described with respect to FIGS. 2A-2J, above, to provide advertisement/campaign content and attributes. This information is used to determine and rank audience cubes that are appropriate or suitable for a given marketing campaign. In FIG. 3D, real-time advertisement recommendations are provided in response to a mobile device accessing one of the publisher sites. The real-time recommender uses advertisement attribute scorecards to determine and recommend advertisements. In addition, information about the transaction (e.g., user response, clicks, device types, location information) is fed back into the system for purposes of tracking and updating the modeling data.

FIGS. 3E-3H illustrate a four-step process according to one embodiment. FIG. 3E illustrates a view of the cold start condition discussed with respect to FIG. 3B, above. FIG. 3F illustrates the generation and updating of audience cubes, using one or more machine learning techniques, including hybrid clustering, canopy with K-means, and augmented univariate analysis. The machine learning techniques cluster data according to many attributes (e.g., device, geography, demographics, publisher site information, time, language, etc.); the determined clusters are then assigned or linked to audience segments, including automobiles, games, news, teens, travel, and the like. FIG. 3G illustrates the generation of modeling scorecards for publisher sites, devices, users, and items (e.g., offers, advertisements). The scorecards are used to efficiently match advertisements that are suitable or otherwise relevant to a received request. FIG. 3H illustrates iteration and update of an existing data model based on batch or real-time behavioral data updates, including (1) information based on impressions, clicks, and responses, and (2) additional or updated information about publisher sites (e.g., as content is changed on a Website).

FIGS. 3I and 3J illustrate data flows provided in the context of a marketer interface. In FIG. 3I, a marketing user (working for one of the Agencies) initially selects audience cubes from a menu and provides advertisement/campaign content/attributes as discussed above. In response the MMS provides recommended and ranked audience cubes. In FIG. 3J, the MMS provides metrics related to the performance of an ongoing campaign. These metrics can be used by the agency to modify attributes of an ongoing campaign (e.g., time of day, demographic target) or make other related decisions (e.g., to increase, decrease, or cancel ad buys).

FIG. 3K illustrates an example architecture for serving advertisements using the described techniques. In this example, an Ad Manager Recommender receives an ad request from or based on a mobile device access. This request if forwarded to an Ad Recommender, which responds with one or more recommended advertisements. The Manager then registers each advertisement with a URL shortening service (e.g., TinyURL), which generates a short URL that corresponds to each advertisement. This shortened URL is then transmitted to the mobile device.

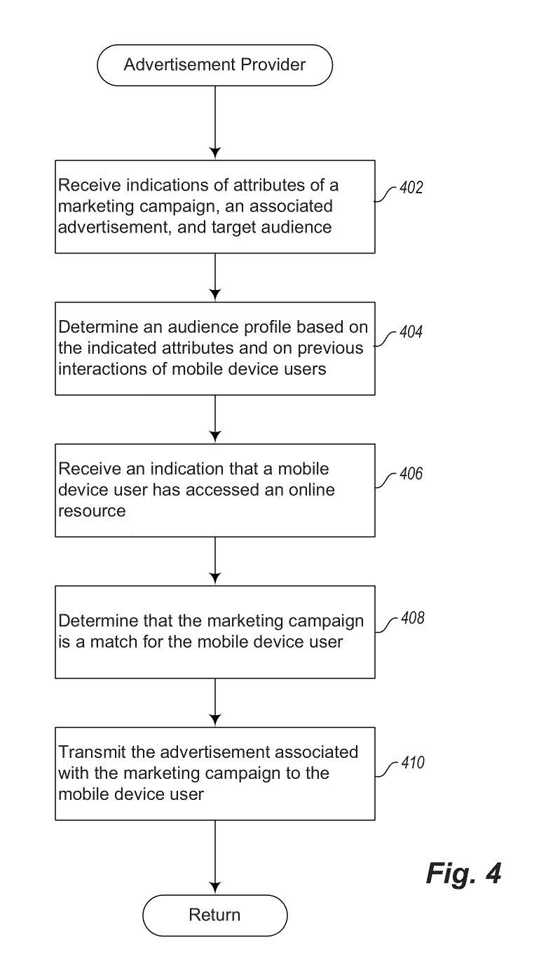

FIG. 4 is a flow diagram of an example advertisement provider process according to an example embodiment. The illustrated process may be performed by one or more components/modules of the mobile marketing platform 110.

The process begins at block 402, where it receives indications of attributes of a marketing campaign, an associated advertisement, and target audience. The advertisement may be a static or dynamic (e.g., video, interactive) advertisement that includes one or more content types, including audio, video, text, or the like.

At block 404, the process determines an audience profile based on the indicated attributes and on previous interactions of mobile device users. Previous interactions may include online resources that have been accessed or downloaded by users, including content items (e.g., audio files, videos, ringtones) or applications (e.g., mobile device apps). In some embodiments, the process operates in conjunction or cooperation with a mobile marketplace where such online resources are offered for sale, and where transactions for such content items may be tracked.

At block 406, the process receives an indication that a mobile device user has accessed an online resource. As noted the online resource may be a content item or application for offer via an online marketplace. In other circumstances, it may be a content item available via an information provider, such as a news Web site. The process may at this point receive information/attributes about the user and/or his device, including location, time of day, device type, demographic information, or the like. Some of this information may be provided by the device (e.g., device operating system type), while other information may be obtained by reference to other sources (e.g., user account information).

At block 408, the process determines that the marketing campaign is a match for the mobile device user. Determining that the marketing campaign is a match for the user may include comparing audience profiles of the marketing campaign (and possibly other marketing campaigns) to the user in order to determine if at least some of the attributes of the user match the attributes of the marketing campaign.

At block 410, the process transmits the advertisement associated with the marketing campaign to the mobile device user. In other embodiments, the process provides an indication of the advertisement to transmit, and the actual transmission of the advertisement is left to some other module.

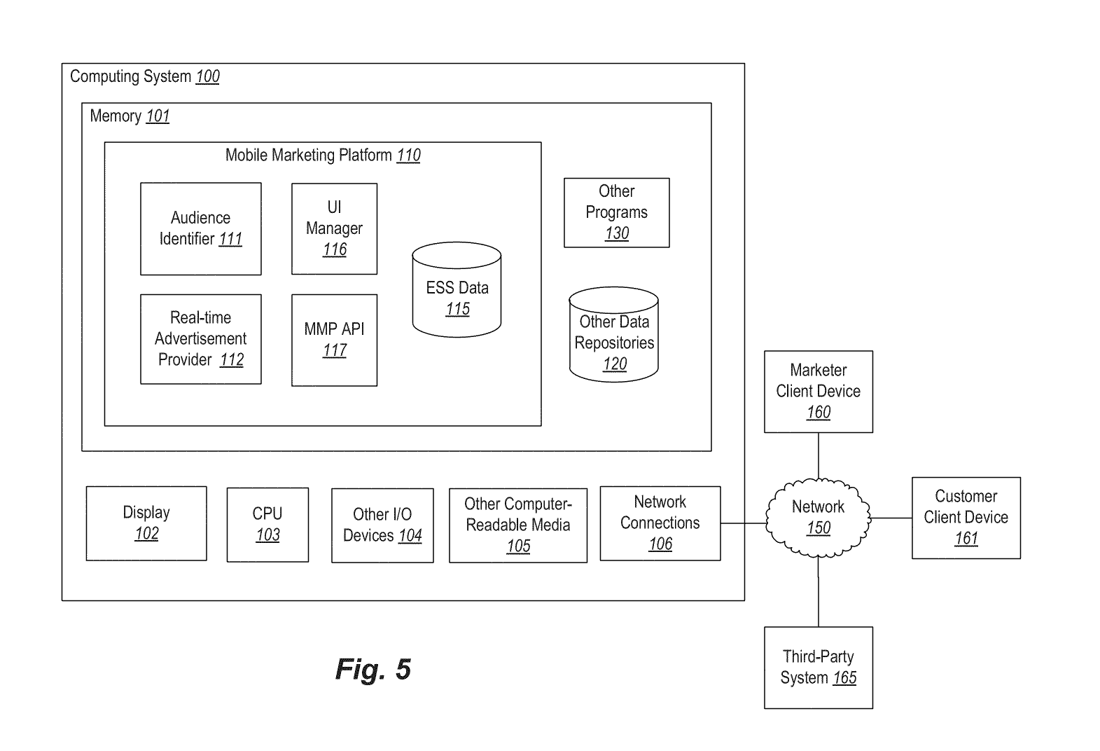

FIG. 5 is a block diagram of an example computing system for implementing a mobile marketing platform according to an example embodiment. In particular, FIG. 5 shows a computing system 100 that may be utilized to implement a mobile marketing platform 110.

Note that one or more general purpose or special purpose computing systems/devices may be used to implement the mobile marketing platform 110. In addition, the computing system 100 may comprise one or more distinct computing systems/devices and may span distributed locations. Furthermore, each block shown may represent one or more such blocks as appropriate to a specific embodiment or may be combined with other blocks. Also, the mobile marketing platform 110 may be implemented in software, hardware, firmware, or in some combination to achieve the capabilities described herein.

In the embodiment shown, computing system 100 comprises a computer memory (“memory”) 101, a display 102, one or more Central Processing Units (“CPU”) 103, Input/Output devices 104 (e.g., keyboard, mouse, CRT or LCD display, and the like), other computer-readable media 105, and network connections 106 connected to a network 150. The mobile marketing platform 110 is shown residing in memory 101. In other embodiments, some portion of the contents, some or all of the components of the mobile marketing platform 110 may be stored on and/or transmitted over the other computer-readable media 105. The components of the mobile marketing platform 110 preferably execute on one or more CPUs 103 and manage marketing campaigns as described herein. Other code or programs 130 (e.g., an administrative interface, a Web server, and the like) and potentially other data repositories, such as data repository 120, also reside in the memory 101, and preferably execute on one or more CPUs 103. Of note, one or more of the components in FIG. 5 may not be present in any specific implementation. For example, some embodiments may not provide other computer-readable media 105 or a display 102.

The mobile marketing platform 110 includes an audience identifier 111, a real-time advertisement provider 112, a user interface (“UI”) manager 116, a mobile marketing platform application program interface (“API”) 117, and a mobile marketing platform data store 115. The audience identifier 111, real-time advertisement provider 112, and data store 115 are described with respect to FIG. 1.

The UI manager 116 provides a view and a controller that facilitate user interaction with the mobile marketing platform 110 and its various components. For example, the UI manager 116 may provide interactive access to the mobile marketing platform 110, such that marketing users can provide information about marketing campaigns and purchase advertising. The UI manager 116 may also provide interactive reporting tools, so that users can better understand the effectiveness of their marketing campaigns. In some embodiments, access to the functionality of the UI manager 116 may be provided via a Web server, possibly executing as one of the other programs 130. In such embodiments, a user operating a Web browser (or other client) executing on the marketer client device 160 can interact with the mobile marketing platform 110 via the UI manager 116.

The API 117 provides programmatic access to one or more functions of the mobile marketing platform 110. For example, the API 117 may provide a programmatic interface to one or more functions of the mobile marketing platform 110 that may be invoked by one of the other programs 130 or some other module. In this manner, the API 117 facilitates the development of third-party software, such as user interfaces, plug-ins, news feeds, adapters (e.g., for integrating functions of the mobile marketing platform 110 into Web applications), and the like.

In addition, the API 117 may be in at least some embodiments invoked or otherwise accessed via remote entities, such as the third-party system 165, to access various functions of the mobile marketing platform 110. For example, an online marketplace executing on or as the third-party system 165 may provide (e.g., upload) via the API 117 information to the mobile marketing platform 110 about transactions executed within the online marketplace.

The data store 115 is used by the other modules of the mobile marketing platform 110 to store and/or communicate information. The components of the MMP 110 use the data store 115 to record various types of information, including about marketing campaigns, customer transaction data, user account data, and the like. Although the components of the MMP 110 are described as communicating primarily through the data store 115, other communication mechanisms are contemplated, including message passing, function calls, pipes, sockets, shared memory, and the like.

The mobile marketing platform 110 interacts via the network 150 with client devices 160 and 161, and third-party systems 165. The network 150 may be any combination of one or more media (e.g., twisted pair, coaxial, fiber optic, radio frequency), hardware (e.g., routers, switches, repeaters, transceivers), and one or more protocols (e.g., TCP/IP, UDP, Ethernet, Wi-Fi, WiMAX) that facilitate communication between remotely situated humans and/or devices. In some embodiments, the network 150 may be or include multiple distinct communication channels or mechanisms (e.g., cable-based and wireless). The client devices 160 and 161 include personal computers, laptop computers, smart phones, personal digital assistants, tablet computers, and the like.

In an example embodiment, components/modules of the mobile marketing platform 110 are implemented using standard programming techniques. For example, the mobile marketing platform 110 may be implemented as a “native” executable running on the CPU 103, along with one or more static or dynamic libraries. In other embodiments, the mobile marketing platform 110 may be implemented as instructions processed by a virtual machine that executes as one of the other programs 130. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the mobile marketing platform 110, such as in the data store 115 and/or 120, can be available by standard mechanisms such as through C, C++, C#, and Java APIs; libraries for accessing files, databases, or other data repositories; through scripting languages such as XML; or through Web servers, FTP servers, or other types of servers providing access to stored data. The illustrated data stores may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the MMP 110 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “includes,” “including,” “comprises,” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for providing advertisements to mobile devices accessing a mobile marketplace, comprising:
receiving indications of attributes of a marketing campaign, an associated advertisement, and target audience;
determining an audience profile based on the indicated attributes and on previous transactions executed by mobile device users in the mobile marketplace;
receiving an indication that a mobile device user has accessed a resource for offer via the mobile marketplace;
determining, based on the determined audience profile and on the mobile device user, that the marketing campaign is a match for the mobile device user; and
transmitting the advertisement associated with the marketing campaign to the mobile device user.

2. The method of claim 1, wherein the marketing campaign is one of multiple marketing campaigns that each have an associated advertisement and determined audience profile, and further comprising:
for each of the multiple marketing campaigns, determining a confidence score that reflects suitability of each marketing campaign for the mobile device user; and
selecting the marketing campaign with the highest confidence score as the match for the mobile device user.

3. The method of claim 1, further comprising updating the determined audience profile one or more times per day based on information about transactions executed by mobile device users in the mobile marketplace.

4. The method of claim 1, wherein determining that the marketing campaign is a match for the mobile device user occurs in substantially real time and in response to the receiving the indication that the user has accessed a resource for offer via the mobile marketplace.

5. The method of claim 1, wherein the resource for offer via the mobile marketplace is a mobile site, a content item, or an application.

6. The method of claim 1, wherein the attributes of the marketing campaign include one or more of a brand name, keywords, a campaign objective, a success metric, and a content channel.

7. The method of claim 1, wherein the attributes of the advertisement include one or more of an advertisement type, a language, an advertisement size, a channel, and an interaction type.

8. The method of claim 1, wherein the attributes of the target audience include one or more of age, gender, income, ethnicity, day of week, time of day, device type, device platform, and geographic region.

9. The method of claim 1, further comprising presenting a campaign scorecard that provides information about relationships between the indicated attributes and transactions executed in the mobile marketplace in response to provided advertisements.

10. A non-transitory computer-readable medium including contents that, when executed by a computing system, causes the computing system to provide advertisements to mobile devices accessing a mobile marketplace, by performing a method comprising:
receiving indications of attributes of a marketing campaign, an associated advertisement, and target audience;
determining an audience profile based on the indicated attributes and on previous transactions executed by mobile device users in the mobile marketplace;
receiving an indication that a mobile device user has accessed a resource for offer via the mobile marketplace;
determining, based on the determined audience profile and on the mobile device user, that the marketing campaign is a match for the mobile device user; and
transmitting the advertisement associated with the marketing campaign to the mobile device user.

11. The computer-readable medium of claim 10 wherein the contents are instructions that when executed cause the computing system to perform the method.

12. The computer-readable medium of claim 10 wherein receiving the indication that the mobile device user has accessed the resource includes receiving indications of a location associated with the mobile device, a time of day, a site accessed by the mobile device, an device type information.

13. A computing system configured to facilitate providing advertisements to mobile devices, comprising:
a processor;
a memory coupled to the processor; and
a module that is stored on the memory and that is configured, when executed by the processor, to perform a method comprising:
receiving indications of attributes of a marketing campaign, an associated advertisement, and target audience;
determining an audience profile based on the indicated attributes and on previous transactions executed by mobile device users in the mobile marketplace;
receiving an indication that a mobile device user has accessed a resource for offer via the mobile marketplace;
determining, based on the determined audience profile and on the mobile device user, that the marketing campaign is a match for the mobile device user; and
transmitting the advertisement associated with the marketing campaign to the mobile device user.

14. The computing system of claim 13 wherein the module includes software instructions for execution in the memory of the computing system.

15. The computing system of claim 13 wherein the module is part of a mobile marketing platform.

16. The computing system of claim 13, wherein the marketing campaign is one of multiple marketing campaigns that each have an associated advertisement and determined audience profile, and further comprising:
for each of the multiple marketing campaigns, determining a confidence score that reflects suitability of each marketing campaign for the mobile device user; and
selecting the marketing campaign with the highest confidence score as the match for the mobile device user.

17. The computing system of claim 13, wherein the method further comprises:
updating the determined audience profile one or more times per day based on information about transactions executed by mobile device users in the mobile marketplace.

18. The computing system of claim 13,
wherein determining that the marketing campaign is a match for the mobile device user occurs in substantially real time and in response to the receiving the indication that the user has accessed a resource for offer via the mobile marketplace;
wherein the resource for offer via the mobile marketplace is a mobile site, a content item, or an application;
wherein the attributes of the marketing campaign include all of a brand name, keywords, a campaign objective, a success metric, and a content channel;
wherein the attributes of the advertisement include all of an advertisement type, a language, an advertisement size, a channel, and an interaction type; and
wherein the attributes of the target audience include all of age, gender, income, ethnicity, day of week, time of day, device type, device platform, and geographic region.
